(19) United States
(12) Patent Application Publication
(10) Pub. No.: US 2007/0117955 A1
(43) Pub. Date: May 24, 2007

(54) Coating composition

(75) Inventors: Anthony Tye, Waterville, OH (US); William H. Plassmann, Waterville, OH (US)

Correspondence Address: BASF CORPORATION;Patent Department, 1609 BIDDLE AVENUE, MAIN BUILDING, WYANDOTTE, MI, 48192, US

(73) Assignee: BASF Corporation, Southfield, MI (US)

(21) Appl. No.: 11/283,592

(22) Filed: Nov. 18, 2005

(51) Int. Cl. C08G 71/04

(52) U.S. Cl. 528/95

(57) ABSTRACT

A coating composition includes a polyurethane polyol and a cross-linking agent. The coating composition is used in original equipment manufacturer (OEM) coating industries. The polyurethane polyol includes the reaction product of an isocyanate component and a first compound having at least two hydroxyl groups. The two hydroxyl groups of the first compound are separated by at least four carbon atoms. The separation of the two hydroxyl groups of the first compound allows the first compound to react with an amount of the isocyanate required to facilitate drying of the coating composition and reduce a chance that contaminants may settle into the coating composition.

### FIELD OF THE INVENTION

The present invention generally relates to a coating composition. More specifically, the present invention relates to a coating composition including a unique polyurethane polyol and a cross-linking agent.

### DESCRIPTION OF THE RELATED ART

Use of coating compositions is essential in both original equipment manufacturer (OEM) coating industries and in refinish coating industries to form basecoat, clearcoat, and other topcoat coatings. The coating compositions can be sprayed onto substrates to form the coatings. The coating compositions may include polyurethane polyols to impart a high solids content to the coating compositions. The high solids content facilitates effective binding and coating of the coating compositions to the substrate and reduces a number of spray applications needed to achieve a desired thickness of the coating composition and/or coatings.

However, use of the coating compositions with the high solids content has disadvantages. A first disadvantage includes a high temperature curing requirement. Some coating compositions that include polyurethane polyols require a high temperature cure in excess of 80° C., thereby increasing energy usage and, therefore, production costs. A second disadvantage includes an extended drying time requirement. Some coating compositions including polyurethane polyols have increased tack times, i.e., the coating compositions dry slowly, allowing contaminants from the air, such as dust, to settle into the coating compositions and form defects in the coatings.

Unsuccessful efforts have been made in the past to eliminate the disadvantages of using the polyurethane polyols in the coating compositions. One effort is disclosed in U.S. Pat. No. 6,753,386 to Yahkind et al. The '386 patent discloses a coating composition including a polyurethane polyol. The polyurethane polyol includes the reaction product of an isocyanate component, a commercially available diol including hydroxyl groups separated by 2 or 3 carbon atoms, and a compound capable of reacting with the isocyanate component. The '386 patent does not disclose a compound including hydroxyl groups separated by 4 or more carbon atoms that is a plentiful by-product of a commercial process. As such, the diols disclosed in the '386 patent increase production costs associated with the coating composition.

A similar effort is disclosed in U.S. Pat. No. 6,624,277, also to Yahkind et al. The '277 patent also discloses a coating composition including a polyurethane polyol. The polyurethane polyol includes the reaction product of an isocyanate component, a polyol, and a Guerbet alcohol. Specifically, the '277 patent discloses use of commercially available polyols including hydroxyl groups separated by 2 or 3 carbon atoms. Like the '386 patent, the '277 patent does not specifically disclose a compound including hydroxyl groups separated by 4 or more carbon atoms that is a plentiful by-product of a commercial process. As such, the diols disclosed in the '277 patent, like the '386 patent, increase production costs.

However, use of compounds including hydroxyl groups separated by 4 or more carbons in the formation of polyurethanes is known in the art. U.S. Pat. No. 2,873,266 to Urs discloses forming polyurethane films by reacting a mixture of commercially available primary and secondary glycols which include 2,5-hexanediol, 2,6-heptanediol, 2,7-octanediol, 1,7-octanediol, 1,6-octanediol, 1,7-nonanediol, and 1,4-cyclohexylene glycol. The mixture of primary and secondary glycols reacts with an aliphatic diisocyanate to form polyurethanes. The '266 patent does not disclose use of the primary and secondary glycols in coating compositions, and does not disclose use of a compound that is a plentiful by-product of a commercial process. The '266 patent also does not disclose use of a cross-linking agent with the primary and secondary glycols and the aliphatic diisocyanate. Rather, the '266 patent focuses on formation of the polyurethane films that are transparent, tough, impervious to oxygen and nitrogen, printable, thermoplastic, and heat-sealable, that can be used for packaging, as leather substitutes, and in formation of threads and fabrics. As such, the compounds disclosed in the '266 patent are not suitable for use in coating composition and are not cost effective.

Therefore, there remains an opportunity for a coating composition to be formed that includes a compound including hydroxyl groups separated by 4 or more carbon atoms where the coating composition to be formed effectively binds to and coats a target, reduces a number of spray applications needed to achieve a desired thickness of the coating composition, and cures at a wide variety of temperatures. The coating composition also dries quickly to reduce a chance that contaminants may settle into the coating composition. Use of the coating composition is cost effective and reduces production costs by eliminating a need to purchase commercially available polyols, glycols, and/or diols.

### SUMMARY OF THE INVENTION AND ADVANTAGES

The present invention provides a coating composition. In a first embodiment, the coating composition includes a polyurethane polyol and a cross-linking agent. The polyurethane polyol includes the reaction product of an isocyanate component and a first compound having at least two hydroxyl groups. The two hydroxyl groups are separated by at least four carbon atoms. The cross-linking agent is different from the isocyanate component. of the present invention may be utilized in any industry. In one embodiment of the present invention, the coating composition is used in original equipment manufacturer (OEM) coating industries. In another embodiment, the coating composition is used in refinish or repair coating industries. The coating composition may be applied to any substrate. In one embodiment, the coating composition is applied to a primer coat of an automobile and serves as a basecoat. In another embodiment, the coating composition is applied to a basecoat of an automobile and serves as a clearcoat. It is also contemplated that the coating composition may be applied to substrates including, but not limited to, metal, plastic, wood, glass, ceramics, polymers, and combinations thereof. The coating composition may also be used in any coating system known in the art. In one embodiment, the coating composition is used in a 1K coating system. In another embodiment, the coating composition is used in a 2K coating system. Additionally, the coating composition may be applied by any application technique known in the art including, but not limited to, spraying, pouring, pan coating, fluidized-bed coating, spinning disk encapsulation, and combinations thereof. One skilled in the art will select the appropriate industry, substrate, coating system, and application technique to utilize with the present invention.

The coating composition includes a polyurethane polyol and a cross-linking agent. The cross-linking agent is described in greater detail below. The polyurethane polyol includes the reaction product of an isocyanate component and a first compound having at least two hydroxyl groups separated by at least four carbon atoms. In one embodiment, the polyurethane polyol includes the reaction product of the isocyanate component, the first compound, and a second compound different from the first compound and reactive with the isocyanate component. The first and second compounds are also described in greater detail below.

The polyurethane polyol preferably has a number average molecular weight (Mₙ) from 300 to 5,000, more preferably from 600 to 4,000, and most preferably from 2,000 to 3,500, g/mol. The polyurethane polyol also preferably has a dispersity, i.e., a ratio of the Mₙ to the weight average molecular weight (M_{w}), from 1.1 to 4, more preferably from 1.1 to 2.5, and most preferably from 1.1 to 2. The polyurethane polyol is preferably present in the coating composition in an amount of less than 45 and more preferably of from 25 to 35, parts by weight per 100 parts by weight of the coating composition.

The isocyanate component used to form the polyurethane polyol is different from the cross-linking agent and may include, but is not limited to, isocyanates, polyisocyanates, biurets of isocyanates and polyisocyanates, isocyanurates of isocyanates and polyisocyanates, and combinations thereof. In one embodiment of the present invention, the isocyanate component includes an n-functional isocyanate. In this embodiment, n is a number preferably from 2 to 5, more preferably from 2 to 4, and most preferably from 3 to 4. It is to be understood that n may be an integer or may have intermediate values from 2 to 5.

The isocyanate component may be selected from the group of aromatic isocyanates, aliphatic isocyanates, and combinations thereof. In one embodiment, the isocyanate component includes an aliphatic isocyanate. If the isocyanate component includes an aliphatic isocyanate, the isocyanate component may also include a modified multivalent aliphatic isocyanate, i.e., a product which is obtained through chemical reactions of aliphatic diisocyanates and/or aliphatic polyisocyanates. Examples include, but are not limited to, ureas, biurets, allophanates, carbodiimides, uretonimines, isocyanurates, urethane groups, dimers, trimers, and combinations thereof. The isocyanate component may also include, but is not limited to, modified diisocyanates employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof.

The isocyanate component may be selected from the group of 1,6-hexane diisocyanates (HDI), biurets of HDI, isocyanurates of HDI, isophorone diisocyanates (IPDI), biurets of IPDI, isocyanurates of IPDI, 2-methyl-1,5-pentane diisocyanate, 2,2,4-trimethyl-1,6-hexamethylene diisocyanate, 2,2,4-trimethyl-1,6-hexane diisocyanate, 1,12-dodecane diisocyanate, methylene bis(4-cyclohexyl isocyanate), and combinations thereof. If the isocyanate component includes IPDI, the IPDI may include, but is not limited to, the biurets and isocyanurates of the IPDI. If the isocyanate component includes HDI, the HDI may include, but is not limited to, the biurets and isocyanurates of the HDI. In one embodiment, the isocyanate component includes an aliphatic polyisocyanurate trimer of HDI commercially available from Bayer Corporation of Pittsburgh, Pa., under the trade name of Desmodur® N 3300. In another embodiment, the isocyanate component includes an aliphatic polyisocyanurate trimer of HDI commercially available from Bayer Corporation of Pittsburgh, Pa., under the trade name of Desmodur® N 3600. In a further embodiment, the isocyanate component includes an aliphatic polyisocyanurate trimer of isophorone diisocyanate commercially available from Bayer Corporation of Pittsburgh, Pa., under the trade name of Desmodur® N 3200.

Alternatively, the isocyanate component may include an aromatic isocyanate. If the isocyanate component includes an aromatic isocyanate, the aromatic isocyanate may correspond to the formula R′(NCO)_{z}, wherein R′is a polyvalent organic radical which is aromatic and z is an integer that corresponds to the valence of R′. Preferably, z is at least two. If the isocyanate component includes the aromatic isocyanate, the isocyanate component may include, but is not limited to, the tetramethylxylylene diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of m-TMXDI and 1,1,1-trimethylolpropane, a reaction product of toluene diisocyanate and 1,1,1-trimethyolpropane, and combinations thereof. The triisocyanate product of m-TMXDI and 1,1,1-trimethylolpropane is commercially available from Cytec Industries, Inc., of West Paterson, N.J., under the trade name of Cythane® 3160.

The isocyanate component preferably has a % NCO content from 10 to 50, more preferably from 10 to 30, and most preferably from 14 to 25, percent by weight. However, the isocyanate component may have any % NCO content. Determination of the % NCO content on percent by weight is accomplished by a standard chemical titration analysis known to those skilled in the art. Further, the isocyanate component may have any viscosity. Preferably, the isocyanate component has a viscosity from 15 to 5,000, more preferably from 100 to 4,000, and most preferably from 500 to 1,000, cps at 25° C. The isocyanate component may also react with the first compound in any amount to form the polyurethane polyol. In one embodiment, the isocyanate component preferably reacts with the first compound in a molar ratio from 1:1 to 3:1, more preferably from 1.5:1 to 2.5:1, and most preferably from 2:1, of the first compound to the isocyanate component.

Referring now to the first compound introduced above, the first compound includes at least two hydroxyl groups. The hydroxyl groups are separated by at least four carbon atoms. It is contemplated that any compound known in the art that includes at least two hydroxyl groups separated by at least four carbon atoms may be used as the first compound in the present invention. If the first compound has more than two hydroxyl groups, it is to be understood that only two of the hydroxyl groups need to be separated by at least four carbons atoms. For example, if the first compound includes a triol or tetrol, only two of the three or four hydroxyl groups, respectively, need be separated by at least four carbon atoms. For descriptive purposes only, the first compound may include the general structure: 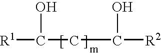
wherein m is an integer of greater than or equal to 2, and wherein R¹ and R² may be the same or may be different and each may include any organic or inorganic moiety known in the art.

In one embodiment, the first compound preferably has from 4 to 12, more preferably from 5 to 10, and most preferably from 6 to 8, carbon atoms. However, the compound may have any number of carbon atoms so long as the hydroxyl groups are separated by at least four carbon atoms. In another embodiment, the hydroxyl groups may be separated by five carbon atoms. In yet another embodiment, the first compound is selected from the group of diols, triols, and combinations thereof. Preferably, the first compound includes a diol. If the first compound includes the diol, the diol may be either a symmetric diol or an asymmetric diol. In one embodiment, the diol is asymmetric. It is to be understood that the terminology “symmetric diol” includes a diol having two hydroxyl groups bound to carbon atoms with the same degree of substitution, such as two primary carbon atoms or two secondary carbon atoms. It is also to be understood that the terminology “asymmetric diol” includes a diol having two hydroxyl groups bound to carbon atoms with different degrees of substitution, such as a primary carbon atom and a secondary carbon atom. If the first compound includes the diol, the first compound may be selected from the group of 1,5-octanediols, 2,5-hexane diols, 2,6-heptane diols, 2,7-octanediols, 1,6-heptanediols, 1,7-octanediols, 1,6-octanediols, 1,7-nonanediols, 1,4-cyclo hexylene glycols, and combinations thereof. Preferably, the first compound includes 2,4-diethyl-1,5-octanediol, which may be a plentiful by-product of a commercial process used to synthesize 2-ethyl-1-hexanol.

Referring now to the second compound introduced above, the second compound is different from the first compound and is also reactive with the isocyanate component. The second compound is preferably selected from the group of alcohols, thiols, amines, and combinations thereof. It is contemplated that any alcohol, thiol, and/or amine may be used in the present invention, including, but not limited to, primary, second, and/or tertiary, linear, branched, cyclic, and/or aromatic, monofunctional, difunctional, or polyfunctional, alcohols, thiols, and amines, and combinations thereof. The second compound preferably has from 1 to 18, more preferably from 1 to 11, and most preferably from 5 to 8, carbon atoms. Examples of suitable second compounds include, but are not limited to, the following structures:
R—OH, R—NH₂, R—SH,
and combinations thereof, wherein R may be selected from an alkyl group, an aromatic group, an alkenyl group, an alkaryl group, and combinations thereof and wherein R may be linear, branched, cyclic, acylic, and combinations thereof. In one embodiment, the second compound is selected from the group of 2-ethyl-1-hexanol, benzyl alcohols, and combinations thereof. In another embodiment, the second compound includes alpha-hydroxytoluene, commonly referred to as benzyl alcohol. The second compound may be reactive with the isocyanate component in any amount. However, in one embodiment, the second compound preferably reacts with the isocyanate component in a molar ratio of less than or equal 2:1, more preferably from 0.5:1 to 1.5:1, and most preferably of 1:1, of the second compound to the isocyanate component.

It is to be understood that the isocyanate component, the first compound, and optionally the second compound, may be reacted in any order. In one embodiment, the isocyanate component is reacted with the first compound, and the second compound is not included. In another embodiment, the isocyanate component is reacted with the first compound and then the second compound. The order of reaction is described in greater detail below and may be selected by one skilled in the art depending on application.

In all embodiments, the isocyanate component and the first compound may be reacted at any temperature. Also, if the second compound is included, the second compound may be reacted at any temperature. In one embodiment, the isocyanate component, the first compound, and the second compound are reacted at a temperature of less than 125, more preferably from 60 to 100, and most preferably from 60 to 80, ° C. Also, the isocyanate component, the first compound, and optionally the second compound, may be reacted for any time. However, the isocyanate component, the first compound, and second compound are preferably reacted for a time from 0.5 to 24, more preferably from 0.5 to 8, and most preferably from 0.5 to 4, hours.

Referring now to the cross-linking agent first introduced above, the cross-linking agent may be any cross-linking agent known in the art. The cross-linking agent reacts with OH functionality of the polyurethane polyol after the polyurethane polyol is formed from the isocyanate component, the first compound, and optionally the second compound. It is also believed that the cross-linking agent increases the number average molecular weight of the polyurethane polyol. The cross-linking agent may be present in the coating composition in any amount. However, in one embodiment, the cross-linking agent is present in the coating composition in an amount of from 5 to 50, more preferably of from 5 to 30, and most preferably of from 10 to 20, parts by weight per 100 parts by weight of the composition.

The cross-linking agent may be selected from the group of isocyanates, aminoplast resins, and combinations thereof. In one embodiment, the cross-linking agent includes the aminoplast resin, such as a melamine formaldehyde resin, particularly suitable for use in original equipment manufacturer (OEM) coating industries. In another embodiment, the cross-linking agent may be any isocyanate known in the art, may be the same or may be different than the isocyanate component, and may be blocked or unblocked. In yet another embodiment, the cross-linking agent includes an unblocked aliphatic isocyanate.

If the cross-linking agent is blocked, the cross-linking agent may be blocked with any blocking agent known in the art. In one embodiment, the blocking agent includes, but is not limited to, ketoximes, alcohols, phenolic compounds, malonic esters, acetoacetates, caprolactams, and combinations thereof.

If the cross-linking agent includes the aminoplast resin, the cross-linking agent may include, but is not limited to, condensation products of an aldehyde and at least one of a melamine, urea, benzoguanamine, and combinations thereof. In one embodiment, the aldehyde includes formaldehyde. However, any aldehyde may be used. Additionally, in another embodiment of the present invention, the aldehyde condensation products include alkylol groups that are partly etherified with an alcohol, such as methanol or butanol, to form alkylated ethers. Suitable examples of the aminoplast resin include, but are not limited to, hexamethoxymethylmelamine, commercially available from Cytec Industries, Inc., under the trade name of Cymel® 303, ether methoxy/butoxy methylmelamine also available from Cytec Industries, Inc., under the trade name of Cymel® 1135, polymeric butoxy methylmelamine commercially available from Cook Composites and Polymers of Kansas City, Mo., under the trade name of M-281-M, high imino polymeric methoxymethylmelamine commercially available from Cytec Industries, Inc., under the trade name of Cymel® 325, and combinations thereof. For descriptive purposes only, the melamine may include the general structure: 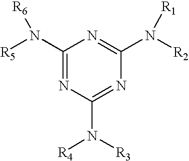
wherein each of R¹ through R⁶ are independently selected from the group of an alkyl group, an alkenyl group, an aromatic group, and alkoxy group, a hydrogen, and combinations thereof. It is to be understood that each of R¹ through R⁶ may be the same or may be different.

The coating composition may also include an acrylic resin or a plurality of acrylic resins. If included, the acrylic resin may be any acrylic resin known in the art and may be included in any amount. In one embodiment, the acrylic resin includes an acrylic polyol commercially available from Johnson Polymer of Sturtevant, Wis. under the trade name of Joncryl® 500. Preferably, the acrylic resin is present in the coating composition in an amount of from 15 to 50, more preferably of from 10 to 50, and most preferably from 20 to 40, parts by weight of non-volatiles per 100 parts by weight of the coating composition.

The coating composition may also include an additive or a plurality of additives. If the additive is included, the additive may be any additive known in the art and may be present in any amount. If included, suitable additives include, but are not limited to, flow additives, surface tension adjustment additives, pigment wetting additives, solvent popping additives, UV absorbers, light stabilizers, co-binders, solvents, thixotropic agents, rheological agents, extenders, pigments, dyes, coloring agents, pigment dispersing agents, surfactants, fillers, chain extenders, anti-foaming agents, processing additives, chain terminators, surface-active agents, adhesion promoters, flame retardants, anti-oxidants, catalysts, solvents, plasticizers, silicone additives, and combinations thereof.

If the additive includes the catalyst, the additive may include any of one or more catalysts known in the art. Although the catalyst may be included in any amount, the catalyst is preferably included in an amount of from 0.001 to 1, more preferably of from 0.005 to 0.2, and most preferably of from 0.005 to 0.01, parts by weight per 100 parts by weight of the coating composition. The catalyst may include an acid catalyst. Particularly suitable acid catalysts include, but are not limited to, p-toluenesulfonic acid (PTSA), dodecylbenzene sulfonic acid (DDBSA), phosphoric acid, alkyl acid phosphates, sulfonic acid, maleic acid, alkyl acid maleates, phenyl acid phosphate (PAP), dinonylnaphthalene disulfonic acid and combinations thereof, and may be blocked or unblocked. PTSA is commercially available from Cytec Industries, Inc., under the trade name of Cycat® 4040. DDBSA is commercially available from Stepan Company of Northfield, Ill., under the trade name of Bio-Soft 5-100. Amine blocked DDBSA is commercially available from King Industries of Norwalk, Conn. under the trade names of Nacure® 5226 and Nacure® XP-158. Amine blocked PTSA is commercially available from Altana Chemie of Wesel, Germany under the trade name of VP-451.

Alternatively, the catalyst may include, but is not limited to, tin, iron, lead, bismuth, mercury, titanium, hafnium, zirconium, and combinations thereof. Suitable catalysts include iron(II) chloride, zinc chloride, lead octoate, dibutyltin dilaurate, and combinations thereof. Other suitable catalysts that include tin(II) salts of organic carboxylic acids, e.g., tin(II) acetate, tin(II) octoate, tin(II) ethylhexanoate and tin(II) laurate, and dialkyltin(IV) salts of organic carboxylic acids, e.g., dibutyltin diacetate, dibutyltin maleate and dioctyltin diacetate.

The catalyst may further include, but is not limited to, tris(dialkylaminoalkyl)-s-hexahydrotriazines, including tris(N,N-dimethylaminopropyl)-s-hexahydrotriazine, tetraalkylammonium hydroxides including tetramethylammonium hydroxide, alkali metal hydroxides including sodium hydroxide and potassium hydroxide, alkali metal alkoxides including sodium methoxide and potassium isopropoxide, alkali metal salts of long-chain fatty acids having from 10 to 20 carbon atoms and/or lateral OH groups, and combinations thereof.

Additionally, the catalyst may be combined with amines including, but not limited to, amidines such as 2,3-dimethyl-3,4,5,6-tetrahydropyrimidine, tertiary amines including, but not limited to, triethylamine, tributylamine, dimethylbenzylamine, N-methylmorpholine, S-ethylmorpholine, N-cyclohexylmorpholine, N,N,N′,N′-tetramethylethylenediamine, N,N,N′,N′-tetramethylbutanediamine, N,N,N′,N′-tetamethylhexane-1,6-diamine, pentamethyldiethylenetriamine, bis(dimethylaminoethyl) ether, bis(dimethylaminopropyl)urea dimethylpiperazine, 1,2-dimethylimidazole, 1-azabicyclo[3.3.0]octane, 1,4-diazabicyclo[2.2.2]octane, alkanolamine compounds such as triethanolamine, triisopropanolamine, N-methyldiethanolamine, N-ethyldiethanolamine, dimethylethanolamine, and combinations thereof.

The additive may also include the solvent. It is to be understood that the additive may include one or more solvents and the solvent may be included in any amount. The solvent may include organic solvents, inorganic solvents, and combinations thereof. In one embodiment, the solvent includes a combination of acetone, methyl n-amyl ketone, and n-butyl acetate. In another embodiment, the solvent includes a combination of xylene, propylene glycol monomethyl ether acetate, and n-butanol. If the additive includes the solvent, the solvent is preferably present in an amount of from 10 to 80, more preferably in an amount of from 20 to 60, and most preferably in an amount of from 30 to 50, parts by weight per 100 parts by weight of the coating composition.

The additive may also include the UV absorber. It is to be understood that the additive may include one or more UV absorbers and the UV absorber may be included in any amount. The UV absorber may also be any UV absorber known in the art. A particularly suitable UV absorber includes, but is not limited to, a hydroxyphenyl benzotriazole commercially available from Ciba Specialty Chemicals of Basel, Switzerland, under the trade name of Tinuvin® 384-2. In one embodiment, the UV absorber is preferably present in an amount of from 0.001 to 0.10, more preferably in an amount of from 0.02 to 0.08, and most preferably in an amount of from 0.02 to 0.06, parts by weight per 100 parts by weight of the coating composition.

The additive may further include the light stabilizer. It is to be understood that the additive may include one or more light stabilizers and the light stabilizer may be included in any amount. The light stabilizer may also be any light stabilizer known in the art. A particularly suitable light stabilizer includes, but is not limited to, a hindered amine, commercially available from Ciba Specialty Chemicals under the trade name of Tinuvin® 292. In one embodiment, the light stabilizer is preferably present in an amount of from 0.0001 to 0.05, more preferably in an amount of from 0.0001 to 0.03, and most preferably in an amount of from 0.0001 to 0.01 parts by weight per 100 parts by weight of the coating composition.

The additive may further include the plasticizer. It is to be understood that the additive may include one or more plasticizers and the plasticizer may be included in any amount. The plasticizer may also include any plasticizer known in the art. A particularly suitable plasticizer includes, but is not limited to, butyl benzyl phthalate, commercially available from the Monsanto Company of St. Louis, Mo., under the trade name of Santicizer® 160. In this embodiment, the plasticizer is preferably present in an amount of from 0.1 to 5, more preferably in an amount of from 0.5 to 2, and most preferably in an amount of from 1 to 1.5, parts by weight per 100 parts by weight of the coating composition.

In still another embodiment, the additive includes the silicone additive. The silicone additive may be any silicone additive known in the art. It is to be understood that the additive may include one or more silicone additives and the silicone additive may be included in any amount. In one embodiment, the additive includes two silicone additives, a first silicone additive and a second silicone additive. Particularly suitable first and second silicone additives include, but are not limited to, a polyoxylalkyl (C₂-C₄) dimethylpolysiloxane commercially available from Degussa AG of Düsseldorf, Germany, under the trade name of Tego® Glide 410, and a polyether modified methylalkylpolysiloxane copolymer, a silicone leveling additive commercially available from Altana Chemie of Wesel, Germany, under the trade name of BYK® 325, respectively. In this embodiment, the first silicone additive is preferably present in an amount of from 0.0001 to 0.5, more preferably of from 0.0001 to 0.0005 and most preferably of from 0.0002 to 0.0004, parts by weight per 100 parts by weight of the coating composition. In this embodiment, the second silicone additive is preferably present in an amount of from 0.001 to 0.5, more preferably of from 0.002 to 0.1, and most preferably of from 0.002 to 0.004, parts by weight per 100 parts by weight of the coating composition.

Further, the additive may include dibutyltin dilaurate as the catalyst, a combination of acetone, methyl n-amyl ketone, and n-butyl acetate as the solvent, Tinuvin® 384-2 as the UV absorber, Tinuvin® 292 as the light stabilizer, butyl benzyl phthalate as the plasticizer, Tego® Glide 410 as the first silicone additive, and BYK® 325 as the second silicone additive, simultaneously.

Alternatively, the additive may include, but is not limited to, a flow additive commercially available from Cook under the trade name of A-620-A2 polybutylacrylate, a flow additive commercially available from Altana Chemie under the trade name of Byk®-320 silicone, a pigment wetting additive commercially available from Altana Chemie under the trade name of such as Disperbyk®, and combinations thereof.

Referring now to the method of forming the coating composition, first introduced above, the method includes the steps of introducing the isocyanate component and the first compound, into a vessel. The method may also include the optional step of introducing the second compound into the vessel. It is to be understood that the isocyanate component, the first compound, and optionally the second compound, may be introduced into the vessel in any order and in any amount. The isocyanate component may be introduced into the vessel first, followed by the first compound and then the second compound. Alternatively, the first compound may be introduced into the vessel first, followed by the isocyanate component and then the second compound. In all embodiments, the vessel may be any vessel known in the art suitable for use in forming the polyurethane polyol. Preferably, the vessel includes a reactor.

The method may include the step of combining the isocyanate component and the first compound. In this embodiment, when the isocyanate component and the first compound are combined, at least a portion of the isocyanate component reacts with at least a portion of the first compound. In an alternative embodiment, all of the isocyanate component reacts with all of the first compound.

In another embodiment, the second compound is introduced into the vessel. In this embodiment, the second compound reacts with the isocyanate component to form the polyurethane polyol. For descriptive purposes only, a reaction schematic of the reaction of the first compound, the isocyanate component, and alpha-hydroxytoluene (benzyl alcohol), as the second compound, to form the polyurethane polyol, is set forth below. This reaction schematic is intended to illustrate an overall reaction and is not intended to be limiting.

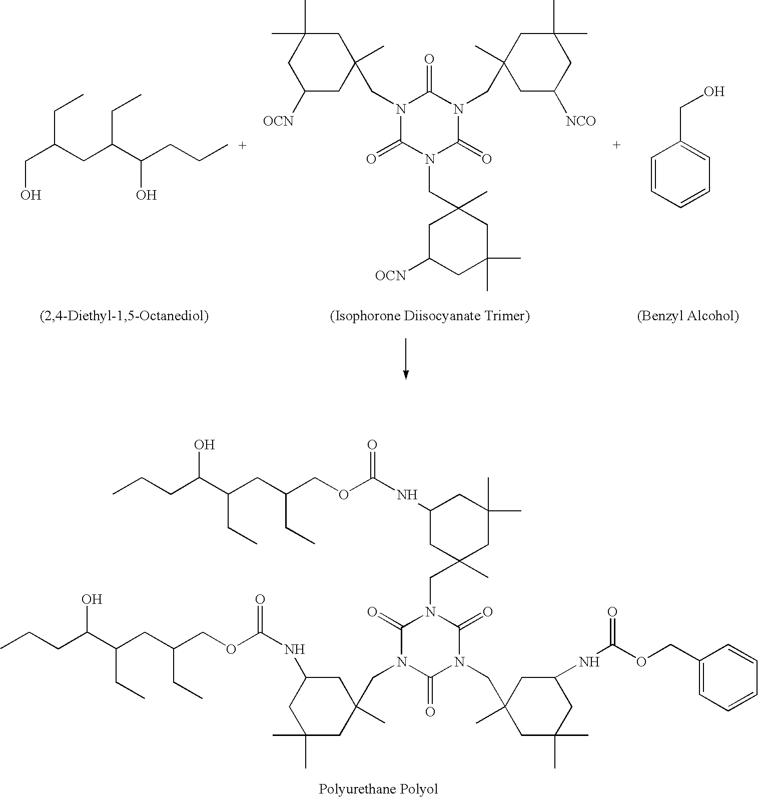

If the isocyanate component reacts with the first compound and the first compound includes a primary and a secondary hydroxyl group, the isocyanate component may preferentially react with the primary hydroxyl group as compared to the secondary hydroxyl group, forming a urethane bond. If so, the secondary hydroxyl group may subsequently react with the cross-linking agent, when the cross-linking agent is introduced into the vessel, described in further detail below.

The method also includes the step of introducing the cross-linking agent. The cross-linking agent may be introduced into the vessel or may be introduced into a second vessel. It is to be understood that the second vessel may be the same type as the first vessel or may be different. The cross-linking agent may be introduced before, after, or simultaneously with the polyurethane polyol and/or the isocyanate component, the first compound, and the second compound. In one embodiment, the polyurethane polyol is formed in the vessel before the cross-linking agent is added to the vessel. In another embodiment, the polyurethane polyol is formed in the vessel and transferred to the second vessel. In this embodiment, the cross-linking agent is then introduced into the second vessel.

When the cross-linking agent is introduced into the vessel, the cross-linking agent is preferably combined with the polyurethane polyol to form the coating composition. Preferably, at least a portion of the polyurethane polyol reacts with at least a portion of the cross-linking agent to form the coating composition. However, all of the polyurethane polyol may react with all of the cross-linking agent to form the coating composition. As first introduced above, if the first compound includes a secondary hydroxyl group, the secondary hydroxyl group may react with the cross-linking agent. For descriptive purposes only, a reaction schematic of the reaction of the polyurethane polyol and the melamine as the cross-linking agent, to form the coating composition, is set forth below. This reaction schematic is intended to illustrate an overall reaction and is not intended to be limiting.

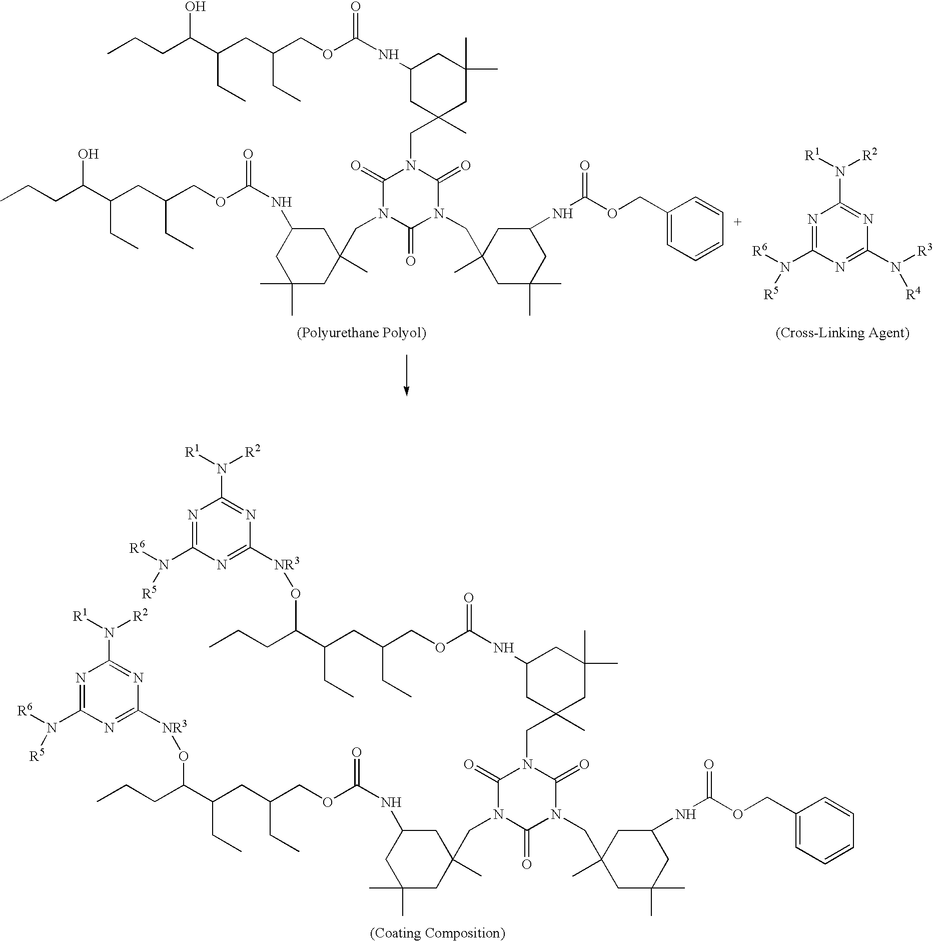

A variety of polyurethane polyols and coating compositions may result from the method of forming the coating composition depending on the order that the isocyanate component, the first compound, the cross-linking agent, and optionally, the second compound, are introduced into the vessel. A specific order may be selected by one skilled in the art depending on the desired polyurethane polyols and coating compositions.

After formation of the coating compound, the coating composition does not require baking. However, it is contemplated that the coating composition may be cured at a temperature exceeding 250° F. for a time of from 10 to 30, and more preferably from 15 to 20, minutes. It is also contemplated that if the coating composition is used in the refinish coating industry with the unblocked isocyanate, the coating composition may be cured at temperatures of from 100 to 200, and more preferably of from 120 to 140° F. If the coating composition is cured, the coating composition may be cured with any curing method known in the art including, but not limited to, applying heat, applying light, and combinations thereof.

The following examples illustrating the formation of and the use of the coating composition of the present invention, as presented herein, are intended to illustrate and not limit the invention.

### EXAMPLES

A coating composition, Coating Composition 1, is formulated according to the present invention. Coating Composition 1 is specifically formed from Polyurethane Polyol 1, also formulated according to the present invention. Two comparative coating compositions, Comparative Coating Compositions 1 and 2 are also formulated. The Comparative Coating Compositions 1 and 2 are specifically formed from Comparative Polyurethane Polyols 1 and 2, respectively. The Comparative Polyurethane Polyols 1 and 2 do not include the First Compound of the present invention. A Control Coating Composition is further formulated and is not formed from the Polyurethane Polyol 1 or either of the Comparative Polyurethane Polyols 1 and 2. The Comparative Coating Compositions 1 and 2 and the Control Coating Composition are described in greater detail below.

### Example 1

To formulate the Polyurethane Polyol 1, a mixture is formed including:

181.8 grams of 2,4-diethyl-1,5-octanediol as the First Compound;

10.8 grams of benzyl alcohol as the Second Compound; and

0.1 grams of the dibutyltin dilaurate as the Catalyst.

After formation, the mixture is mixed and held at 70° C. 181 grams of an aliphatic polyisocyanurate trimer of HDI as the Isocyanate Component, commercially available from Bayer Corporation of Pittsburgh, Pa., under the trade name of Desmodur® N 3600, is then combined with 95 grams of n-butyl acetate as the Solvent Additive, and added to the mixture at 70° C. The mixture is then stirred for approximately 2.6 hours and allowed to cool, thus forming the Polyurethane Polyol 1. An endpoint is determined by NCO titration according to ASTM D2572-87. Once a 0% NCO value is reached, 118.5 grams of n-butyl acetate as the Solvent Additive is added to the Polyurethane Polyol 1 to thin the Polyurethane Polyol 1. 337 grams of the Polyurethane Polyol 1 are then added to 1283.6 grams of a Master Batch of a Clearcoat, to form the coating composition of the present invention, Coating Composition 1. The Master Batch of the Clearcoat includes:

140.2 grams of xylene as the Solvent Additive;

144.4 grams of propylene glycol monomethyl ether acetate as the Solvent Additive;

55.2 grams of n-butanol as the solvent additive;

508.7 grams of an acrylic polyol, commercially available from Johnson Polymer of Sturtevant, Wis., under the trade name of Joncryl® 500, as the First Acrylic Resin;

2.5 grams of ethyl acrylate-2-ethylhexyl acrylate copolymer, commercially available from Solutia, Inc. of St. Louis, Mo., under the trade name of Modaflow® 2100, as the Second Acrylic Resin;

0.5 grams of a liquid hindered-amine light stabilizer, commercially available from Ciba Specialty Chemicals of Basel, Switzerland, under the trade name of Tinuvin® 292, as the Light Stabilizer Additive;

63.7 grams of a hydroxyphenylbenzotriazole UV light absorber, commercially available from Ciba Specialty Chemicals of Basel, Switzerland, under the trade name of Tinuvin® 328, as the UV Absorber Additive;

358.9 grams of a methylated-butylated melamine resin, commercially available from Surface Specialties, Inc. of Smyrna, Ga., under the trade name of Resimene® 775, as the Cross-Linking Agent; and

9.5 grams of dodecylbenzene sulfonic acid, as the Catalyst.

### Comparative Example 1

To formulate the Comparative Polyurethane Polyol 1, 143.8 grams of 2-ethyl-1,3-hexane diol is substituted for the 2,4-diethyl-1,5-octanediol as the First Compound in the mixture. 337 grams of the Comparative Polyurethane Polyol 1 is added to 1283.6 grams of the Master Batch of the Clearcoat to form Comparative Coating Composition 1.

### Comparative Example 2

To formulate Comparative Polyurethane Polyol 2, 84.8 grams of 1,2-propane diol is substituted for the 2,4-diethyl-1,5-octanediol as the First Compound in the mixture. 337 grams of the Comparative Polyurethane Polyol 2 is added to 1283.6 grams of the Master Batch of the Clearcoat to form Comparative Coating Composition 2.

### Control Example

To formulate the Control Coating Composition, neither the Polyurethane Polyol 1 nor the Comparative Polyurethane Polyols 1 and 2 are utilized. As such, the Control Coating Composition includes the Master Batch of the Clearcoat.

After formation, the Coating Composition, the Comparative Coating Compositions 1 and 2, and the Control Coating Composition are evaluated for viscosity and American Public Health Association (APHA) color, both initially and after 6 days. Specifically, the viscosity is evaluated using ASTM D1200-94 including a number four Ford Cup at room temperature. Also, the APHA color is evaluated using ASTM D1209. The results of the viscosity and APHA color evaluations are set forth in Table 1, wherein all components are in grams unless otherwise noted.

TABLE 1

| | | Compar- | Compar- | |
|---|---|---|---|---|
| | | ative | ative | Control |
| | Coating | Coating | Coating | Coating |
| | Compo- | Compo- | Compo- | Compo- |
| Component | sition 1 | sition 1 | sition 2 | sition |
| Polyisocyanurate | 181 | 181 | 181 | 0 |
| trimer of HDI | | | | |
| 2-Ethyl-1,3- | 0 | 143.8 | 0 | 0 |
| Hexane Diol | | | | |
| 1,2-Propane | 0 | 0 | 84.8 | 0 |
| Diol | | | | |
| 2,4-Diethyl-1,5- | 181.8 | 0 | 0 | 0 |
| Octanediol | | | | |
| Dibutyltin | 0.1 | 0.1 | 0.1 | 0.1 |
| Dilaurate | | | | |
| Benzyl Alcohol | 10.8 | 10.8 | 10.8 | 10.8 |
| n-Butyl Acetate | 213.5 | 213.5 | 213.5 | 213.5 |
| Master Batch of | 1283.6 | 1283.6 | 1283.6 | 1283.6 |
| Clearcoat | | | | |
| APHA Color | 30 | 30 | 80 | 40 |
| Initial | | | | |
| APHA Color-6 | 40 | 80 | 300 | 60 |
| Days | | | | |
| Viscosity Initial | 14.9 | 17 | 18 | 17 |
| (sec) | | | | |
| Viscosity-6 | 15.3 | 18.1 | 18.8 | 18 |
| Days (sec) | | | | |

As shown in Table 1, the APHA color of the Coating Composition 1 is generally equivalent to or lower than the APHA color of the Comparative Coating Compositions 1 and 2 and the Control Coating Composition. The APHA color of the Coating Composition 1 contributes to the ability to be used in clearcoat automotive coatings. As also shown in Table 1, the viscosity of the Coating Composition 1 is generally lower than the viscosity of the Comparative Coating Compositions 1 and 2 and the Control Coating Composition. The viscosity of the Coating Composition 1 also contributes to a decreased need to utilize organic solvents and decreases potential environmental pollution.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A coating composition comprising:
A. a polyurethane polyol comprising the reaction product of;
(1) an isocyanate component, and
(2) a first compound having at least two hydroxyl groups separated by at least four carbon atoms; and
B. a cross-linking agent different from said isocyanate component.

2. A coating composition as set forth in claim 1 wherein said first compound has from 5 to 10 carbon atoms.

3. A coating composition as set forth in claim 2 wherein said hydroxyl groups are separated by five carbon atoms.

4. A coating composition as set forth in claim 3 wherein said first compound is selected from the group of diols, triols, and combinations thereof.

5. A coating composition as set forth in claim 4 wherein said diol comprises an asymmetric diol.

6. A coating composition as set forth in claim 4 wherein said first compound is selected from the group of 1,5-octanediols, 2,5-hexanediols, 2,6-heptanediols, 2,7-octanediols, 1,6-heptanediols, 1,7-octanediols, 1,6-octanediols, 1,7-nonanediols, 1,4-cyclo hexylene glycols, and combinations thereof.

7. A coating composition as set forth in claim 1 wherein said first compound comprises 2,4-diethyl-1,5-octanediol.

8. A coating composition as set forth in claim 1 wherein said isocyanate component comprises an n-functional polyisocyanate wherein n is from 2 to 4.

9. A coating composition as set forth in claim 1 wherein said isocyanate component is selected from the group of 1,6-hexane diisocyanates, biurets of 1,6-hexane diisocyanate, isocyanurates of 1,6-hexane diisocyanate, isophorone diisocyanates, biurets of isophorone diisocyanate, isocyanurates of isophorone diisocyanate, 2-methyl-1,5-pentane diisocyanate, 2,2,4-trimethyl-1,6-hexamethylene diisocyanate, 2,2,4-trimethyl-1,6-hexane diisocyanate, 1,12-dodecane diisocyanate, methylene bis(4-cyclohexyl isocyanate), and combinations thereof.

10. A coating composition as set forth in claim 1 wherein said isocyanate component comprises an aliphatic polyisocyanurate trimer of isophorone diisocyanate.

11. A coating composition as set forth in claim 1 wherein said isocyanate component comprises an aliphatic polyisocyanurate trimer of 1,6-hexane diisocyanate.

12. A coating composition as set forth in claim 1 wherein said isocyanate component reacts with said first compound in a molar ratio of from 1.5:1 to 2.5:1 of said first compound to said isocyanate component.

13. A coating composition as set forth in claim 1 wherein said polyurethane polyol further comprises the reaction product of a second compound different from said first compound and reactive with said isocyanate component.

14. A coating composition as set forth in claim 13 wherein said second compound reacts with said isocyanate component in a molar ratio of from 0.5:1 to 1.5:1 of said second compound to said isocyanate component.

15. A coating composition as set forth in claim 13 wherein said isocyanate component comprises isophorone diisocyanate, said first compound comprises 2,4-diethyl-1,5-octanediol, said second component comprises alpha-hydroxytoluene, and said cross-linking agent comprises an unblocked aliphatic isocyanate different from said isophorone diisocyanate.

16. A coating composition as set forth in claim 13 wherein said second compound is selected from the group of alcohols, thiols, amines, and combinations thereof.

17. A coating composition as set forth in claim 16 wherein said second compound has from 1 to 11 carbon atoms.

18. A coating composition as set forth in claim 17 wherein said second compound is selected from the group of 2-ethyl-1-hexanol, benzyl alcohols, and combinations thereof.

19. A coating composition as set forth in claim 1 wherein said cross-linking agent is selected from the group of isocyanates, aminoplast resins, and combinations thereof.

20. A coating composition as set forth in claim 1 wherein said cross-linking agent comprises an unblocked aliphatic isocyanate different from said isocyanate component.

21. A coating composition as set forth in claim 1 wherein said cross-linking agent is present in said coating composition in an amount of from 5 to 30, parts by weight per 100 parts by weight of the coating composition.

22. A coating composition as set forth in claim 1 wherein said polyurethane polyol has a dispersity from 1.1 to 2.5.

23. A coating composition as set forth in claim 1 wherein said polyurethane polyol has a number average molecular weight from 600 to 3000 g/mol.

24. A coating composition as set forth in claim 1 wherein said polyurethane polyol is present in said coating composition in an amount of from 25 to 35 parts by weight per 100 parts by weight of said coating composition.

25. A coating composition comprising:
A. a polyurethane polyol comprising the reaction product of;
(1) an isocyanate component,
(2) 2,4-diethyl-1,5-octanediol, and
(3) an alcohol; and
B. an aliphatic isocyanate different from said isocyanate component.

26. A method of forming a coating composition comprising the steps of:
A. introducing an isocyanate component into a vessel; and
B. introducing a first compound into the vessel wherein the first compound has at least two hydroxyl groups separated by at least four carbons; and
C. introducing a cross-linking agent different from the isocyanate component.

27. A method of forming a coating composition as set forth in claim 26 further comprising the step of combining the isocyanate component and the first compound.

28. A method of forming a coating composition as set forth in claim 27 further comprising the step of introducing a second compound into the vessel that is different from the first compound and reactive with the isocyanate component.

29. A method of forming a coating composition as set forth in claim 28 further comprising the step of combining the cross-linking agent and the polyurethane polyol to form the coating composition.
